(19) United States
(12) Patent Application Publication
(10) Pub. No.: US 2025/0212122 A1
(43) Pub. Date: Jun. 26, 2025

(54) INFORMATION TRANSMISSION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/846,795

(22) PCT Filed: Mar. 17, 2022
(86) PCT No.: PCT/CN2022/081558

§ 371 Date: Sep. 13, 2024

(51) Int. Cl. H04W 52/02; H04W 8/24; H04W 24/08; H04W 76/27

(52) U.S. Cl. CPC H04W 52/0235; H04W 8/24; H04W 24/08; H04W 76/27

(57) ABSTRACT

The embodiments of the present disclosure relate to an information transmission method and apparatus, and a communication device and a storage medium. The method includes sending first capability indication information for indicating whether the UE supports an auxiliary receiver. The auxiliary receiver is at least used to monitor a wake-up signal in response to that a main radio of the UE is in a sleep state.

### CROSS REFERENCE TO RELATED APPLICATION

The present application is a U.S. National Stage of International Application No. PCT/CN2022/081558, filed on Mar. 17, 2022, the contents of which are incorporated herein by reference in its entirety for all purposes.

### TECHNICAL FIELD

The present application relates to, but is not limited to, the wireless communication technical field, and in particular to an information transmission method and apparatus, a communication device and a storage medium.

### BACKGROUND

In cellular mobile communication technologies, a power-saving signal is used to indicate a monitoring behavior of a UE to play a role in saving power. For example, a base station may send a power-saving signal to indicate whether the UE monitors a Physical Downlink Control Channel (PDCCH); when the UE receives the power-saving signal, the UE monitors the PDCCH corresponding to the power-saving signal; otherwise, the UE may remain in a power-saving state such as a sleep state and does not monitor the PDCCH, so as to save power.

### SUMMARY

In view of the above, embodiments of the present disclosure provide an information transmission method, an information transmission apparatus, a communication device, and a storage medium.

According to a first aspect of an embodiment of the present disclosure, there is provided an information transmission method. The method is performed by User Equipment (UE), and the method includes:
sending first capability indication information for indicating whether the UE supports an auxiliary receiver, wherein the auxiliary receiver is at least used to monitor a wake-up signal when a main radio of the UE is in a sleep state.

According to a second aspect of an embodiment of the present disclosure, there is provided an information transmission method. The method is performed by a base station, and the method includes:
receiving first capability indication information for indicating whether a UE supports an auxiliary receiver, wherein the auxiliary receiver is at least used to monitor a wake-up signal when a main radio of the UE is in a sleep state.

According to a third aspect of an embodiment of the present disclosure, there is provided an information transmission method. The method is performed by a core network, and the method includes:
receiving first capability indication information for indicating whether a UE supports an auxiliary receiver, wherein the auxiliary receiver is at least used to monitor a wake-up signal when a main radio of the UE is in a sleep state.

According to a further aspect of an embodiment of the present disclosure, there is provided a communication device. The communication device includes a processor, a memory, and an executable program stored in the memory and executable by the processor. When the executable program is executed by the processor, steps of the information transmission method described in the first aspect, the second aspect, or the third aspect are implemented.

According to a further aspect of an embodiment of the present disclosure, there is provided a non-transitory computer-readable storage medium, on which an executable program is stored. When the executable program is executed by a processor, steps of the information transmission method described in the first aspect, the second aspect, or the third aspect are implemented.

It should be understood that the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of the specification, illustrate embodiments consistent with the present disclosure and, together with the specification, serve to explain the principles of the embodiments of the present disclosure.

FIG. 1 is a schematic structural diagram of a wireless communication system according to an example embodiment;

FIG. 2 is a schematic flowchart of an information transmission method according to an example embodiment;

FIG. 3 is a schematic flowchart of another information transmission method according to an example embodiment;

FIG. 4 is a schematic flowchart of yet another information transmission method according to an example embodiment;

FIG. 5 is a schematic flowchart of yet another information transmission method according to an example embodiment;

FIG. 6 is a schematic flowchart of yet another information transmission method according to an example embodiment;

FIG. 7 is a schematic flowchart of yet another information transmission method according to an example embodiment;

FIG. 8 is a schematic flowchart of yet another information transmission method according to an example embodiment;

FIG. 9 is a block diagram of an information transmission apparatus according to an example embodiment;

FIG. 10 is a block diagram of another information transmission apparatus according to an example embodiment;

FIG. 11 is a block diagram of yet another information transmission apparatus according to an example embodiment;

FIG. 12 is a block diagram showing a device for information transmission according to an example embodiment.

### DETAILED DESCRIPTION

Reference will now be made in detail to example embodiments, examples of which are illustrated in the accompanying drawings. When the following description refers to the accompanying drawings, the same numerals in different drawings refer to the same or similar elements unless otherwise indicated. The implementations described in the following example embodiments do not represent all implementations consistent with the embodiments of the present disclosure. Rather, they are merely examples of apparatuses and methods consistent with aspects of the disclosed embodiments as recited in the appended claims.

Terms used in the embodiments of the present disclosure are for the purpose of describing specific embodiments only, and are not intended to limit the embodiments of the present disclosure. As used in the examples of the present disclosure and the appended claims, singular forms “a/an”, “said” and “the” are also intended to include a plural form unless the context clearly indicates otherwise. It should also be understood that the term “and/or” as used herein refers to and includes any or all possible combinations of one or more of associated listed items.

It should be understood that although the terms first, second, third, etc. may be used to describe various information in the embodiments of the present disclosure, the information should not be limited by these terms. These terms are only used to distinguish information of the same type from each other. For example, without departing from the scope of the embodiments of the present disclosure, first information may also be called second information, and similarly second information may also be called first information. Depending on the context, the word “if” as used herein may be interpreted as “when” or “upon . . . ” or “in response to determining . . . ”.

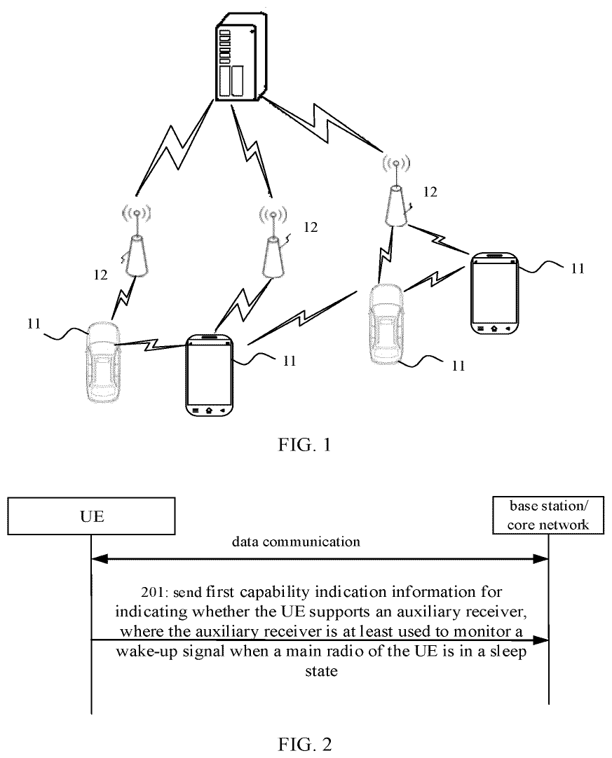

FIG. 1 shows a schematic structural diagram of a wireless communication system provided by an embodiment of the present disclosure. As shown in FIG. 1, the wireless communication system is a communication system based on a cellular mobile communication technology, and the wireless communication system may include: several terminal devices 11 and several base stations 12.

A terminal device 11 may be a device that provides voice and/or data connectivity to a user. The terminal device 11 may communicate with one or more core networks via a Radio Access Network (RAN). The terminal device 11 may be an Internet of Things terminal, such as a sensor device, a mobile phone (or called “cellular phone”), and a computer with an Internet of Things terminal, for example, it may be a fixed, portable, pocket-sized, handheld, computer-built-in or vehicle-mounted device, for example, Station (STA), subscriber unit, subscriber station, mobile station, mobile, remote station, access point, remote terminal, access terminal, user terminal, user agent, user device, or User Equipment (UE). Alternatively, the terminal device 11 may be equipment of an unmanned aerial vehicle. Alternatively, the terminal device 11 may be a vehicle-mounted device, for example, a trip computer with a wireless communication function, or a wireless communication device connected externally to a trip computer. Alternatively, the terminal device 11 may be a roadside device, for example, it may be a streetlight, a signal light or other roadside device with a wireless communication function.

A base station 12 may be a network side device in a wireless communication system. The wireless communication system may be a 4th generation mobile communication (4G) system, also known as a Long Term Evolution (LTE) system; or, the wireless communication system may be a 5G system, also called New Radio (NR) system or 5G NR system. Alternatively, the wireless communication system may be a next-generation system of the 5G system. An access network in the 5G system may be called New Generation-Radio Access Network (NG-RAN), or a MTC system.

The base station 12 may be an evolved base station (eNB) adopted in a 4G system. Alternatively, the base station 12 may be a base station (gNB) adopting a centralized and distributed architecture in the 5G system. When the base station 12 adopts a centralized and distributed architecture, it generally includes a central unit (CU) and at least two distributed units (DUs). The central unit is provided with a protocol stack of a Packet Data Convergence Protocol (PDCP) layer, a Radio Link Control (RLC) layer, and Media Access Control (MAC) layer protocol stack; the distributed unit is provided a physical (PHY) layer protocol stack; embodiments of the present disclosure do not limit the specific implementation of the base station 12.

A wireless connection may be established between the base station 12 and the terminal device 11 through a wireless air interface. In different implementations, the wireless air interface is a wireless air interface based on the fourth-generation mobile communication network technology (4G) standard; or, the wireless air interface is a wireless air interface based on the fifth-generation mobile communication network technology (5G) standard, such as the wireless air interface is a new air interface; alternatively, the wireless air interface may also be a wireless air interface based on a technical standard of a next-generation mobile communication network based on 5G.

In some embodiments, an End to End (E2E) connection may be established between terminal devices 11. For example, Vehicle to Vehicle (V2V) communication, Vehicle to Infrastructure (V2I) communication and Vehicle to Pedestrian (V2P) communication in Vehicle to everything (V2X) communication and so on.

In some embodiments, the foregoing wireless communication system may further include a network management device 13.

Several base stations 12 are connected to the network management device 13 respectively. The network management device 13 may be a core network device in the wireless communication system. For example, the network management device 13 may be a Mobility Management Entity (MME) in Evolved Packet Core (EPC). Alternatively, the network management device may be other core network device, such as a Serving GateWay (SGW), a Public Data Network GateWay (PGW), a Policy and Charging Rules Function (PCRF) or Home Subscriber Server (HSS), etc. The implementation form of the network management device 13 is not limited in the embodiments of the present disclosure.

The execution entities involved in the embodiments of the present disclosure include, but are not limited to: a mobile phone terminal and a network side device in a cellular mobile communication system, and the network side device may include for example, an access network device such as a base station, and a core network.

In the power-saving project specified in the cellular mobile communication protocol of 3GPP Release 16 (hereinafter referred to as R16), for a UE in a connected state, a power-saving signal, namely a wakeup signal (WUS) or power-saving downlink control information (DCP, DCI for powersaving), is introduced. The WUS is a low power consumption detection signal. If the WUS is detected by a UE, it means that the UE needs to monitor the PDCCH; otherwise, the UE skips monitoring of the PDCCH.

In the power-saving project specified in the cellular mobile communication protocol of 3GPP Release 17 (hereinafter referred to as R17), for a Discontinuous Reception (DRX) scenario in an idle state, the power-saving signal: Paging Earlier Indication (PEI) is usually configured before a Paging Occasion (PO). If the power-saving signal is not detected by the UE, the UE needs to ignore the Paging Downlink Control Information (paging DCI); otherwise, the UE needs to monitor the paging DCI in the PO. And, for the connected state, enhancement is made to introduce a PDCCH skipping mechanism, that is, PDCCH skipping is carried in the DCI to inform a user to skip a period of monitoring or switch a search space group.

No matter what kind of power-saving signal, a modem or a main radio of a terminal needs to perform detection of the power-saving signal. The modem or the main radio consumes more power when monitoring the power-saving signal.

In the related art, an auxiliary receiver (i.e., an ultra-low power wake-up receiver) is introduced to monitor the power-saving signal. After the auxiliary receiver receives the power-saving signal, the auxiliary receiver triggers the modem or the main radio of the terminal to wake up; otherwise, part of the main radio or the modem will remain in a sleep state, thereby saving power.

How to perform UE capability reporting and introduce the auxiliary receiver into the communication procedure of a UE to save power in the procedure of monitoring a power-saving signal is an urgent problem to be solved.

As shown in FIG. 2, an example embodiment provides an information transmission method. The method may be performed by User Equipment (UE) in a cellular mobile communication system. The method includes:

In step 201, first capability indication information for indicating whether the UE supports an auxiliary receiver is sent. The auxiliary receiver is at least used to monitor a wake-up signal when a main radio of the UE is in a sleep state.

The auxiliary receiver may be a wireless device independent of the main radio in the UE. The auxiliary receiver may also have the capability of receiving wireless signals. It should be noted that the auxiliary receiver may be implemented by a chip, or a function of the auxiliary receiver may be implemented by code software, and the implementations of the present disclosure do not limit this. In one possible implementation, in order to improve the power saving effect, an existing baseband chip may be used as the main radio, and another auxiliary chip may be used as an auxiliary receiver; and the aforementioned auxiliary chip may be a chip with relatively low power consumption and weaker function than the baseband chip. In another possible implementation, in order to improve the power saving effect, the function of the auxiliary receiver is implemented by code software. It should be noted that the naming of “auxiliary receiver” does not mean that the chip or the function can only perform receiving; the auxiliary receiver in the embodiments of the present disclosure can have only a receiving function, or it can have both a receiving function and a sending function. In one possible implementation, the auxiliary receiver may be in an always-on state. In one possible implementation, the auxiliary receiver may also be in a periodic wake-up state, that is, the auxiliary receiver may be in a wake-up state when the main radio is sleep; or the auxiliary receiver may wake up periodically to receive signals when the main radio is sleep, and the wake-up period of the auxiliary receiver is smaller than the wake-up period of the main radio.

The main radio may be a wireless signal receiving and transmitting device in the UE for receiving and transmitting radio frequency signals for air interface communications. The main radio may be for example a modem or a baseband chip, etc.

Resources occupied by the auxiliary receiver during communications may be less than resources occupied by the main radio during communications. For example, the power consumption of the auxiliary receiver is less than the power consumption of the main radio. The wake-up signal may be a signal for indicating the UE to wake up from a sleep state and monitor predetermined information. The predetermined information may be a paging DCI transmitted via a PDCCH resource, etc.

In one embodiment, the wake-up signal may include but is not limited to: WUS and/or PEI, etc.

The auxiliary receiver may monitor the wake-up signal when the main radio is in a sleep state. When the auxiliary receiver receives the wake-up signal, the UE may wake up the main radio to monitor the predetermined information. In this way, the main radio does not need to monitor the wake-up signal. Since the power consumption of the auxiliary receiver is low, monitoring the wake-up signal by the auxiliary receiver can reduce power consumption and save UE power.

The UE may use capability indication information to report the UE's capability of supporting the auxiliary receiver to network side device(s) such as a base station and/or a core network. After receiving the capability indication information, the network side may determine whether the UE supports the auxiliary receiver.

For example, resource(s) for receiving the wake-up signal by the auxiliary receiver may be the same as or different from resource(s) for receiving the wake-up signal by the main radio. Here, the resource(s) for receiving the wake-up signal may include at least one of the following: a time domain resource, a frequency domain resource, or a coding resource. A signal quality requirement for receiving the wake-up signal by the auxiliary receiver may be the same as or different from a signal quality requirement for receiving the wake-up signal by the main radio.

In one embodiment, a first wake-up signal received by the auxiliary receiver is different from a second wake-up signal received by the main radio. For example, the first wake-up signal received by the auxiliary receiver may include, but is not limited to: ultra-low power PEI and/or low power WUS, and so on. The second wake-up signal received by the main radio may be PEI specified in the R17 communication protocol. The resources and/or signal quality requirements of the first wake-up signal and the second wake-up signal may be different.

The network side, such as the base station and/or the core network, may determine whether the UE supports the auxiliary receiver based on the capability indication information, so that the wake-up signal may be sent according to the signal quality requirements and resources for the UE to receive the wake-up signal, thereby improving the reliability of wake-up signal transmission. For example, if the network side determines that the UE supports the auxiliary receiver based on the capability indication information, the network side may transmit a first wake-up signal to the UE. If the network side determines that the UE does not support the auxiliary receiver based on the capability indication information, the network side may transmit a second wake-up signal to the UE.

The capability indication information may be carried in other signaling. For example, the capability indication information may be a field in existing signaling. Alternatively, the capability indication information may be dedicated signaling.

For example, the capability indication information may use two different logic type values to indicate whether the UE supports the auxiliary receiver. For example, “0” may be used to indicate that the UE does not support the auxiliary receiver, and “1” may be used to indicate that the UE supports the auxiliary receiver. Alternatively, “1” may be used to indicate that the UE does not support the auxiliary receiver, and “0” may be used to indicate that the UE supports the auxiliary receiver.

In one embodiment, the capability indication information may only indicate that the UE supports the auxiliary receiver. That is, the capability indication information may only explicitly indicate that the UE supports the auxiliary receiver; when the UE does not send the capability indication information, it implicitly indicates that the UE does not support the auxiliary receiver. Alternatively, the capability indication information may only indicate that the UE does not support the auxiliary receiver. When the UE does not send the capability indication information, it implicitly indicates that the UE supports the auxiliary receiver.

In this way, by sending the first capability indication information by the UE, the network side can determine whether the UE supports the auxiliary receiver, thereby reducing the misjudgment of the auxiliary receiver support capability of the UE due to the network side's uncertainty of the auxiliary receiver support capability of the UE, and improving the accuracy in determining the auxiliary receiver support capability of the UE by the network side.

In one embodiment, sending the first capability indication information for indicating whether the UE supports the auxiliary receiver includes:
sending UE capability information carrying the first capability indication information.

That is, the capability indication information may be sent with the capability indication carried in UE capability information (UECapabilityInformation). The capability indication information may be used to report parameter(s)/capability (capabilities) such as the radio frequency capability of the UE to the network side.

In a possible implementation, the base station may send a UE capability enquiry (UECapabilityEnquiry) instruction to the UE. After the UE receives the UECapabilityEnquiry instruction, the UE reports the UE capability information according to the instruction. The UE capability information may carry capability indication information indicating whether the UE supports the auxiliary receiver.

In one embodiment, if the base station or the core network determines that the UE supports using the auxiliary receiver to receive the first wake-up signal, it can be determined that the UE supports using the main radio and/or the auxiliary receiver to receive the second wake-up signal, where the first wake-up signal is different from the second wake-up signal.

The first wake-up signal may include, but is not limited to: ultra-low power PEI. The second wake-up signal may be PEI specified in the R17 communication protocol.

The resources and/or signal quality requirements of the first wake-up signal and the second wake-up signal may be different. The first wake-up signal and the second wake-up signal may have a binding relationship. That is, if the UE supports using the auxiliary receiver to receive the first wake-up signal, the UE necessarily supports using the auxiliary receiver to receive the second wake-up signal.

Alternatively, the first wake-up signal and the second wake-up signal may not have a binding relationship. That is, if the UE supports using the auxiliary receiver to receive the first wake-up signal, the UE does not necessarily use the auxiliary receiver to support the second wake-up signal.

In one embodiment, the first capability indication information further includes: auxiliary receiver working indication information, wherein the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

When the UE supports the auxiliary receiver, whether the UE enables the auxiliary receiver to monitor the wake-up signal may also be indicated to the network side by the UE through the auxiliary receiver working indication information. That is, the UE may control whether to enable the auxiliary receiver and indicate it to the network side device such as the base station or the core network. For example, the UE may report that the UE wants to currently work in a working mode using the auxiliary receiver.

When the UE supports the auxiliary receiver, the time information for the UE to enable the auxiliary receiver to monitor the wake-up signal may be indicated to the network side by the UE through the auxiliary receiver working indication information.

The time information may be used to indicate at least one of the following parameters of the working of the auxiliary receiver: a duration, wake-up start time, wake-up end time, a wake-up period, or a wake-up interval.

In this way, by the auxiliary receiver working indication information which indicates whether to use the auxiliary receiver to monitor the wake-up signal, and/or the time information for the auxiliary receiver to monitor the wake-up signal, on the one hand, the UE can flexibly control the working state of the auxiliary receiver. On the other hand, based on the auxiliary receiver working indication information, the network side can send to the UE a wake-up signal which is currently suitable for the UE to receive, thereby reducing the misjudgment of the UE state by the network side.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

The capability indication information may indicate whether the UE supports the auxiliary receiver in the RRC connected state and/or the RRC non-connected state. The RRC non-connected state may include: an RRC idle state and/or an RRC inactive state.

For example, the capability indication information may not be distinguishable between RRC states. That is, the capability indication information indicates whether the UE supports the auxiliary receiver, which may be applicable to both the RRC connected state and the RRC non-connected state. For example, the capability indication information indicates that the UE supports the auxiliary receiver, which means that the UE supports the auxiliary receiver regardless of whether the UE is in the RRC connected state or the RRC non-connected state.

As another example, the first capability indication information may be distinguishable between RRC states. That is, the first capability indication information indicates whether the UE supports the auxiliary receiver, and may be applicable only to the RRC connected state or the RRC non-connected state at the same time. For example, the capability indication information may indicate that the UE supports the auxiliary receiver when the UE is in the RRC non-connected state, and does not support the auxiliary receiver when the UE is in the RRC connected state, etc.

In one embodiment, sending the first capability indication information for indicating whether the UE supports the auxiliary receiver includes at least one of the following:
sending the first capability indication information to the core network; or
sending the first capability indication information to the base station.

The UE may determine whether itself supports the auxiliary receiver, and accordingly the UE may send capability indication information to the network side device to indicate whether the UE supports the auxiliary receiver. In a possible implementation, the network side device may be a base station or a core network device.

For example, the capability indication information may be sent to the base station with the capability indication information carried in UE capability information (UECapabilityInformation) or an uplink assistance message or other signaling.

As another example, the capability indication information may be reported to the core network via Non-Access Stratum (NAS) signaling.

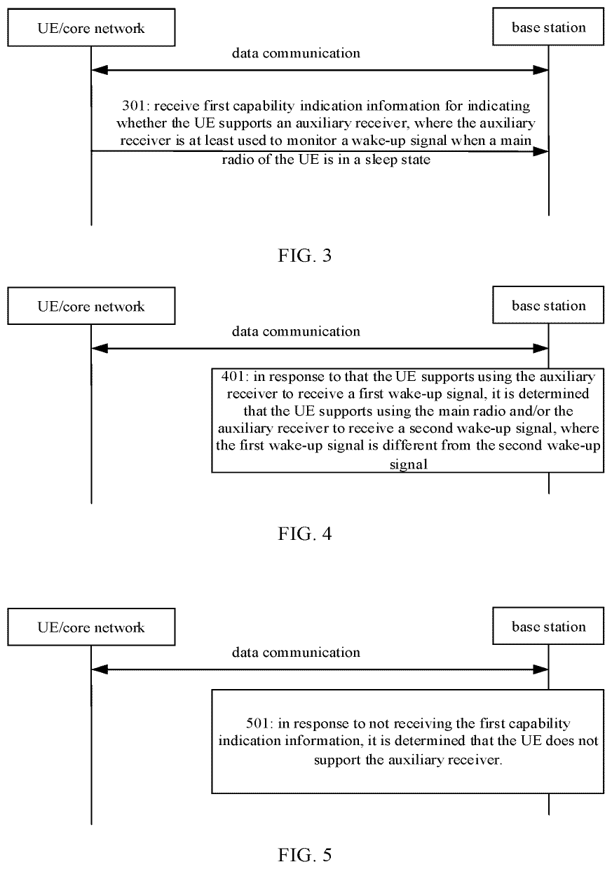

As shown in FIG. 3, an example embodiment provides an information transmission method. The method may be performed by a base station of a cellular mobile communication system. The method includes:

In step 301, first capability indication information for indicating whether a UE supports an auxiliary receiver is received. The auxiliary receiver is at least used to monitor a wake-up signal when a main radio of the UE is in a sleep state.

For the definitions of the auxiliary receiver and the main radio, reference may be made to the descriptions of other embodiments in the present disclosure and will not be repeated here.

The wake-up signal may be a signal for indicating the UE to wake up from a sleep state and monitor predetermined information. The predetermined information may be a paging DCI transmitted via a PDCCH resource, etc.

In one embodiment, the wake-up signal may include but is not limited to: WUS and/or PEI, etc.

The auxiliary receiver may monitor the wake-up signal when the main radio is in a sleep state. When the auxiliary receiver receives the wake-up signal, the UE may wake up the main radio to monitor the predetermined information. In this way, the main radio does not need to monitor the wake-up signal. Since the power consumption of the auxiliary receiver is low, monitoring the wake-up signal by the auxiliary receiver can reduce power consumption and save UE power.

The UE may use capability indication information or other information to report the UE's capability of supporting the auxiliary receiver to network side device(s) such as the base station and/or the core network. After receiving the capability indication information, the base station may determine whether the UE supports the auxiliary receiver. The UE's capability of supporting the auxiliary receiver may be reported by the UE to the core network, and the core network may send the UE's capability of supporting the auxiliary receiver to the base station through capability indication information. Alternatively, the UE's capability of supporting the auxiliary receiver may be reported by a first base station to the core network, and the core network may send the UE's capability of supporting the auxiliary receiver to a second base station through capability indication information.

For example, resource(s) for receiving the wake-up signal by the auxiliary receiver may be the same as or different from resource(s) for receiving the wake-up signal by the main radio. Here, the resource(s) for receiving the wake-up signal may include at least one of the following: a time domain resource, a frequency domain resource, or a coding resource. The signal quality requirement for receiving the wake-up signal by the auxiliary receiver may be the same as or different from the signal quality requirement for receiving the wake-up signal by the main radio.

In one embodiment, a first wake-up signal received by the auxiliary receiver is different from a second wake-up signal received by the main radio. For example, the first wake-up signal received by the auxiliary receiver may include, but is not limited to: ultra-low power PEI and/or low power WUS. The second wake-up signal received by the main radio may be PEI specified in the R17 communication protocol. The resources and/or signal quality requirements of the first wake-up signal and the second wake-up signal may be different.

The network side, such as the base station, can determine whether the UE supports the auxiliary receiver according to the capability indication information, so that the network side can send the wake-up signal according to the signal quality requirement and resource for the UE to receive the wake-up signal, thereby improving the reliability of wake-up signal transmission. For example, if the network side determines that the UE supports the auxiliary receiver according to the capability indication information, the network side can transmit the first wake-up signal to the UE. If the network side determines that the UE does not support the auxiliary receiver according to the capability indication information, the network side can transmit the second wake-up signal to the UE.

The capability indication information may be carried in other signaling. For example, the capability indication information may be a field in existing signaling. Alternatively, the capability indication information may be dedicated signaling.

For example, the capability indication information may use two different logic type values to indicate whether the UE supports the auxiliary receiver. For example, “0” may be used to indicate that the UE does not support the auxiliary receiver, and “1” may be used to indicate that the UE supports the auxiliary receiver. Alternatively, “1” may be used to indicate that the UE does not support the auxiliary receiver, and “0” may be used to indicate that the UE supports the auxiliary receiver.

In one embodiment, the capability indication information may only indicate that the UE supports the auxiliary receiver. That is, the capability indication information may only explicitly indicate that the UE supports the auxiliary receiver; when the UE does not send the capability indication information, it implicitly indicates that the UE does not support the auxiliary receiver. Alternatively, the capability indication information may only indicate that the UE does not support the auxiliary receiver. When the UE does not send the capability indication information, it implicitly indicates that the UE supports the auxiliary receiver.

In this way, by sending the first capability indication information from the UE, the network side can determine whether the UE supports the auxiliary receiver, thereby reducing the misjudgment of the auxiliary receiver support capability of the UE due to the network side's uncertainty of the auxiliary receiver support capability of the UE, and improving the accuracy in determining the auxiliary receiver support capability of the UE by the network side.

In one embodiment, receiving the first capability indication information for indicating whether the UE supports the auxiliary receiver includes:
receiving UE capability information carrying the first capability indication information.

That is, the capability indication information may be sent with the capability indication information carried in UE capability information (UECapabilityInformation). The capability indication information may be used to report parameter(s)/capability (capabilities) such as the radio frequency capability of the UE to the network side.

In a possible implementation, the base station may send a UE capability enquiry (UECapabilityEnquiry) instruction to the UE. After the UE receives the UECapabilityEnquiry instruction, the UE reports the UE capability information according to the instruction. The UE capability information may carry capability indication information indicating whether the UE supports the auxiliary receiver.

As shown in FIG. 4, an example embodiment provides an information transmission method. The method may be performed by a base station in a cellular mobile communication system. The method includes:

In step 401, in response to that the UE supports using the auxiliary receiver to receive a first wake-up signal, it is determined that the UE supports using the main radio and/or the auxiliary receiver to receive a second wake-up signal, where the first wake-up signal is different from the second wake-up signal.

Here, step 401 may be implemented alone or in combination with step 301.

The first wake-up signal may include, but is not limited to: ultra-low power PEI. The second wake-up signal may be PEI specified in the R17 communication protocol.

The resources and/or signal quality requirements of the first wake-up signal and the second wake-up signal may be different. The first wake-up signal and the second wake-up signal may have a binding relationship. That is, if the UE supports using the auxiliary receiver to receive the first wake-up signal, the UE necessarily supports using the auxiliary receiver to receive the second wake-up signal.

Alternatively, the first wake-up signal and the second wake-up signal may not have a binding relationship. That is, if the UE supports using the auxiliary receiver to receive the first wake-up signal, the UE does not necessarily use the auxiliary receiver to support the second wake-up signal.

As shown in FIG. 5, an example embodiment provides an information transmission method. The method may be performed by a base station in a cellular mobile communication system. The method includes:

In step 501, in response to not receiving the first capability indication information, it is determined that the UE does not support the auxiliary receiver.

Here, step 501 may be implemented alone or in combination with step 301 and/or step 401.

The capability indication information may only indicate that the UE supports the auxiliary receiver. That is, the capability indication information may only explicitly indicate that the UE supports the auxiliary receiver; when the UE does not send the capability indication information, it implicitly indicates that the UE does not support the auxiliary receiver.

For example, a communication protocol stipulates that UE capability information (UECapabilityInformation) is used to carry capability indication information indicating that the UE supports the auxiliary receiver; if the base station does not find capability indication information indicating that the UE supports the auxiliary receiver in the UE capability information, the base station can determine that the UE does not support the auxiliary receiver.

In one embodiment, the first capability indication information further includes: auxiliary receiver working indication information, where the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

When the UE supports the auxiliary receiver, whether the UE enables the auxiliary receiver to monitor the wake-up signal may also be indicated by the UE to the network side such as the base station through the auxiliary receiver working indication information. That is, the UE can control whether to enable the auxiliary receiver and indicate it to the network side device such as the base station or the core network. For example, the UE can report that the UE wants to currently work in the working mode using the auxiliary receiver.

When the UE supports the auxiliary receiver, time information for the UE to enable the auxiliary receiver to monitor the wake-up signal may be indicated to the network side by the UE through the auxiliary receiver working indication information.

The time information may be used to indicate at least one of the following parameters of the working of the auxiliary receiver: a duration, wake-up start time, wake-up end time, a wake-up period, or a wake-up interval.

In this way, by the auxiliary receiver working indication information which indicates whether to use the auxiliary receiver to monitor the wake-up signal, and/or the time information for the auxiliary receiver to monitor the wake-up signal, on the one hand, the UE can flexibly control the working state of the auxiliary receiver. On the other hand, based on the auxiliary receiver working indication information, the network side can send to the UE a wake-up signal which is currently suitable for the UE to receive, thereby reducing the network side's misjudgment of the UE state.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

The capability indication information may indicate whether the UE supports the auxiliary receiver in the RRC connected state and/or the RRC non-connected state. The RRC non-connected state may include: an RRC idle state and/or an RRC inactive state.

For example, the capability indication information may not be distinguishable between RRC states. That is, the capability indication information indicates whether the UE supports the auxiliary receiver, which may be applicable to both the RRC connected state and the RRC non-connected state. For example, the capability indication information indicates that the UE supports the auxiliary receiver, which means that the UE supports the auxiliary receiver regardless of whether the UE is in the RRC connected state or the RRC non-connected state.

As another example, the first capability indication information may be distinguishable between the RRC states. That is, the first capability indication information indicates whether the UE supports the auxiliary receiver, and may be applicable only to the RRC connected state or the RRC non-connected state at the same time. For example, the capability indication information may indicate that the UE supports the auxiliary receiver when the UE is in the RRC non-connected state, and the UE does not support the auxiliary receiver when the UE is in the RRC connected state, etc.

In one embodiment, receiving the first capability indication information for indicating whether the UE supports the auxiliary receiver includes at least one of the following:
receiving the first capability indication information sent by the UE;
receiving the first capability indication information sent by the core network; or
receiving the first capability indication information sent by an opposite base station.

The UE can determine whether itself supports the auxiliary receiver, and accordingly the UE can send the capability indication information to the network side device to indicate whether the UE supports the auxiliary receiver. In a possible implementation, the network side device can be a base station or a core network device.

For example, the capability indication information may be sent to the base station with the capability indication information carried in UE capability information (UECapabilityInformation) or an uplink assistance message or other signaling.

In one embodiment, the reported capability of the terminal may be transmitted between the core network and the base station.

For example, the capability indication information may be reported by the UE to the core network through NAS signaling, and the capability indication information may be sent by the core network to the base station, and the capability indication information indicates whether the UE supports the auxiliary receiver.

As an example, the core network may carry the capability indication information in a paging message and transmit it to the base station.

In one embodiment, the paging message may carry capability indication information indicating that the UE can support the auxiliary receiver. If the paging message does not carry the capability indication information, it implicitly indicates that the UE does not support the auxiliary receiver.

For example, the core network may carry the capability indication information in, but not limited to, the following message(s):
INITIAL CONTEXT SETUP REQUEST;
UE CONTEXT MODIFICATION REQUEST;
HANDOVER REQUEST; or
PATH SWITCH REQUEST ACKNOWLEDGE.

The UE's capability of whether the auxiliary receiver is supported may also be transmitted between base stations. A base station may send the capability indication information to an opposite base station.

For example, the UE may be a UE in an inactive state, and the opposite base station may be an anchor base station of the UE. When the UE camps on the anchor base station, the UE may report its capability of whether the auxiliary receiver is supported. The anchor base station keeps the capability indication information of whether the UE supports the auxiliary receiver. When the UE performs cell reselection within the coverage of the opposite base station, the opposite base station may send the capability indication information to the reselected base station to indicate whether the UE supports the auxiliary receiver, and the reselected base station can determine whether the UE supports the auxiliary receiver.

In one embodiment, the capability indication information may be carried in an interaction message in a context acquisition procedure.

For example, the capability indication information may be carried in a context response and transmitted from the anchor base station to a non-anchor base station.

In one embodiment, the capability indication information may be carried in an access network paging (RAN P aging) message.

In one embodiment, the method further includes at least one of the following:
sending to the opposite base station second capability indication information for indicating whether the UE supports the auxiliary receiver; or
sending to the core network the second capability indication information for indicating whether the UE supports the auxiliary receiver.

The UE's capability of whether the auxiliary receiver is supported may also be transmitted between base stations. A base station may send the capability indication information to an opposite base station.

For example, the UE may be a UE in an inactive state, and when the UE camps on an anchor base station, the UE may report its capability of whether the auxiliary receiver is supported. The opposite base station may be a base station for the UE to reselect a cell, and the anchor base station keeps first capability indication information of whether the UE supports the auxiliary receiver. When the UE performs cell selection within the coverage of the opposite base station, the anchor base station may send to the opposite base station second capability indication information to indicate whether the UE supports the auxiliary receiver, and the opposite base station may determine whether the UE supports the auxiliary receiver.

In one embodiment, the capability indication information may be carried in an interaction message in the context acquisition procedure.

For example, the capability indication information may be carried in a context response and transmitted from the anchor base station to a non-anchor base station.

In one embodiment, the capability indication information may be carried in an access network paging (RAN P aging) message.

The reported capability of the terminal may be transmitted between the core network and a base station;

In one embodiment, the UE reports to the base station its capability of whether the UE supports the auxiliary receiver through capability indication information, and the base station then notifies the UE's capability to the core network through the capability indication information; the capability indication information may indicate whether the UE supports the auxiliary receiver.

For example, the capability indication information may be carried in, but not limited to, the following message:
UE CAPABILITY INFORMATION; or
RRC INACTIVE TRANSITION REPORT.

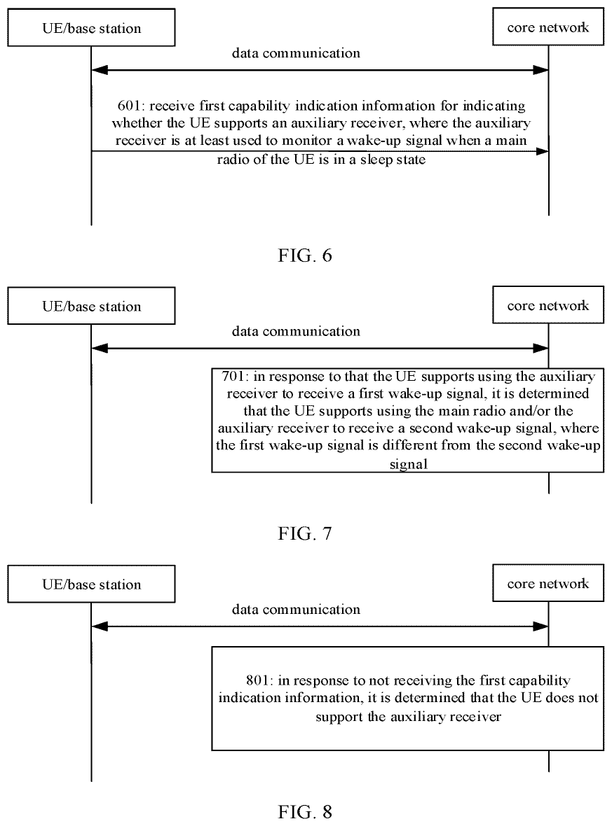

As shown in FIG. 6, an example embodiment provides an information transmission method. The method may be performed by a core network in a cellular mobile communication system. The method includes:

In step 601, first capability indication information for indicating whether a UE supports an auxiliary receiver is received. The auxiliary receiver is at least used to monitor a wake-up signal when a main radio of the UE is in a sleep state.

For the definitions of the auxiliary receiver and the main radio, reference may be made to the descriptions of other embodiments in the present disclosure and will not be repeated here.

The wake-up signal may be a signal for indicating the UE to wake up from a sleep state and monitor predetermined information. The predetermined information may be a paging DCI transmitted via a PDCCH resource, etc.

In one embodiment, the wake-up signal may include but is not limited to: WUS and/or PEI, etc.

The auxiliary receiver may monitor the wake-up signal when the main radio is in a sleep state. When the auxiliary receiver receives the wake-up signal, the UE may wake up the main radio to monitor the predetermined information. In this way, the main radio does not need to monitor the wake-up signal. Since the power consumption of the auxiliary receiver is low, monitoring the wake-up signal by the auxiliary receiver can reduce power consumption and save UE power.

The UE may use capability indication information to report the UE's capability of supporting the auxiliary receiver to network side device(s) such as a base station and/or a core network. The base station may also send the capability indication information reported by the UE to the core network. After receiving the capability indication information, the core network may determine whether the UE supports the auxiliary receiver.

For example, resource(s) for receiving the wake-up signal by the auxiliary receiver may be the same as or different from resource(s) for receiving the wake-up signal by the main radio. Here, the resource(s) for receiving the wake-up signal may include at least one of the following: a time domain resource, a frequency domain resource, or a coding resource. The signal quality requirement for receiving the wake-up signal by the auxiliary receiver may be the same as or different from the signal quality requirement for receiving the wake-up signal by the main radio.

In one embodiment, the first wake-up signal received by the auxiliary receiver is different from the second wake-up signal received by the main radio. For example, the first wake-up signal received by the auxiliary receiver may include, but is not limited to, ultra-low power PEI and/or low power WUS. The second wake-up signal received by the main radio may be PEI specified in the R17 communication protocol. The resources and/or signal quality requirements of the first wake-up signal and the second wake-up signal may be different.

The network side such as the core network can determine whether the UE supports the auxiliary receiver based on the capability indication information, so that network side can send the wake-up signal according to the signal quality requirement and resource for the UE to receive the wake-up signal, thereby improving the reliability of wake-up signal transmission. For example, if the network side determines that the UE supports the auxiliary receiver based on the capability indication information, the network side can transmit a first wake-up signal to the UE. If the network side determines that the UE does not support the auxiliary receiver based on the capability indication information, the network side can transmit a second wake-up signal to the UE.

The capability indication information may be carried in other signaling. For example, the capability indication information may be a field in existing signaling. Alternatively, the capability indication information may be dedicated signaling.

For example, the capability indication information may use two different logic type values to indicate whether the UE supports the auxiliary receiver. For example, “0” may be used to indicate that the UE does not support the auxiliary receiver, and “1” may be used to indicate that the UE supports the auxiliary receiver. Alternatively, “1” may be used to indicate that the UE does not support the auxiliary receiver, and “0” may be used to indicate that the UE supports the auxiliary receiver.

In one embodiment, the capability indication information may only indicate that the UE supports the auxiliary receiver. That is, the capability indication information may only explicitly indicate that the UE supports the auxiliary receiver; when the UE does not send the capability indication information, it implicitly indicates that the UE does not support the auxiliary receiver. Alternatively, the capability indication information may only indicate that the UE does not support the auxiliary receiver. When the UE does not send the capability indication information, it implicitly indicates that the UE supports the auxiliary receiver.

In this way, by sending the first capability indication information by the UE, the network side can determine whether the UE supports the auxiliary receiver, thereby reducing the misjudgment of the auxiliary receiver support capability of the UE due to the network side's uncertainty of the auxiliary receiver support capability of the UE, and improving the accuracy in determining the auxiliary receiver support capability of the UE by the network side.

In one embodiment, receiving the first capability indication information for indicating whether the UE supports the auxiliary receiver includes:
receiving UE capability information carrying the first capability indication information.

The UE or the base station may carry the capability indication information through the UE capability information. The UE capability information may be used for, but not limited to, reporting to the network side the radio frequency capability of the UE and so on.

For example, the capability indication information may be sent to the base station with the capability indication information carried in UE capability information (UECapabilityInformation) or an uplink assistance message, and the base station may send a user equipment capability information indication (UE CAPABILITY INFO INDICATION) message carrying the capability indication information to the core network.

As shown in FIG. 7, an example embodiment provides an information transmission method. The method may be performed by a core network in a cellular mobile communication system. The method includes:

In step 701, in response to that the UE supports using the auxiliary receiver to receive a first wake-up signal, it is determined that the UE supports using the main radio and/or the auxiliary receiver to receive a second wake-up signal, where the first wake-up signal is different from the second wake-up signal.

Here, step 701 may be implemented alone or in combination with step 601.

The first wake-up signal may include, but is not limited to, ultra-low power PEI. The second wake-up signal may be PEI specified in the R17 communication protocol.

The resources and/or signal quality requirements of the first wake-up signal and the second wake-up signal may be different. The first wake-up signal and the second wake-up signal may have a binding relationship. That is, if the UE supports using the auxiliary receiver to receive the first wake-up signal, the UE necessarily supports using the auxiliary receiver to receive the second wake-up signal.

Alternatively, the first wake-up signal and the second wake-up signal may not have a binding relationship. That is, if the UE supports using the auxiliary receiver to receive the first wake-up signal, the UE does not necessarily support using the auxiliary receiver to support the second wake-up signal.

As shown in FIG. 8, an example embodiment provides an information transmission method. The method may be performed by a core network in a cellular mobile communication system. The method includes:

In step 801, in response to not receiving the first capability indication information, it is determined that the UE does not support the auxiliary receiver.

The capability indication information may only indicate that the UE supports the auxiliary receiver. That is, the capability indication information may only explicitly indicate that the UE supports the auxiliary receiver; when the UE does not send the capability indication information, it implicitly indicates that the UE does not support the auxiliary receiver.

For example, a communication protocol stipulates that a user equipment capability indication (UE CAPABILITY INFO INDICATION) message is used to carry the capability indication information for indicating that the UE supports the auxiliary receiver; if the core network does not find capability indication information indicating that the UE supports the auxiliary receiver in the user equipment capability indication message, the core network may determine that the UE does not support the auxiliary receiver.

In one embodiment, the first capability indication information further includes: auxiliary receiver working indication information, where the auxiliary receiver working indication information is used to indicate at least one of the following:
when the UE supports the auxiliary receiver, whether to use the auxiliary receiver to monitor the wake-up signal; or
when the UE supports the auxiliary receiver, time information for the auxiliary receiver to monitor the wake-up signal.

When the UE supports the auxiliary receiver, whether the UE enables the auxiliary receiver to monitor the wake-up signal may be indicated by the UE to the network side such as the base station through the auxiliary receiver working indication information. That is, the UE can control whether to enable the auxiliary receiver and indicate it to the network side device such as the base station or the core network. For example, the UE can report that the UE wants to currently work in the working mode using the auxiliary receiver.

When the UE supports the auxiliary receiver, time information for the UE to enable the auxiliary receiver to monitor the wake-up signal may be indicated by the UE to the network side through the auxiliary receiver working indication information.

The time information may be used to indicate at least one of the following parameters of the working of the auxiliary receiver: a duration, wake-up start time, wake-up end time, a wake-up period, or a wake-up interval.

In this way, by the auxiliary receiver working indication information which indicates whether to use the auxiliary receiver to monitor the wake-up signal, and/or the time information of the auxiliary receiver monitoring the wake-up signal, on the one hand, the UE can flexibly control the working state of the auxiliary receiver. On the other hand, based on the auxiliary receiver working indication information, the network side can send to the UE a wake-up signal which is currently suitable for the UE to receive, thereby reducing the misjudgment of the UE state by the network side.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

The capability indication information may indicate whether the UE supports the auxiliary receiver in the RRC connected state and/or the RRC non-connected state. The RRC non-connected state may include: an RRC idle state and/or an RRC inactive state.

For example, the capability indication information may not be distinguishable between RRC states. That is, the capability indication information indicates whether the UE supports the auxiliary receiver, which may be applicable to both the RRC connected state and the RRC non-connected state. For example, the capability indication information indicates that the UE supports the auxiliary receiver, which means that the UE supports the auxiliary receiver regardless of whether the UE is in the RRC connected state or the RRC non-connected state.

Exemplarily, the first capability indication information may be distinguishable between RRC states. That is, the first capability indication information indicates whether the UE supports the auxiliary receiver, and may be applicable only to the RRC connected state or the RRC non-connected state at the same time. For example, the capability indication information may indicate that the UE supports the auxiliary receiver when the UE is in the RRC non-connected state, and the UE does not support the auxiliary receiver when the UE is in the RRC connected state, etc.

In one embodiment, receiving the first capability indication information for indicating whether the UE supports the auxiliary receiver includes at least one of the following:
receiving the first capability indication information sent by the UE; or
receiving the first capability indication information sent by a base station.

The capability indication information may be reported by the UE to the core network through NAS signaling.

The UE may also report whether the UE supports the auxiliary receiver capability to the base station through capability indication information, and the base station then notifies the UE's capability to the core network through capability indication information; the capability indication information may indicate whether the UE supports the auxiliary receiver.

For example, the capability indication information may be carried in, but not limited to, the following message:
UE CAPABILITY INFORMATION; or
RRC INACTIVE TRANSITION REPORT.

In one embodiment, the method further includes:
sending to a base station second capability indication information for indicating whether the UE supports the auxiliary receiver.

The reported capability of the terminal can be transmitted between the core network and a base station.

For example, the capability indication information may be reported by the UE to the core network through NAS signaling, and the capability indication information may be sent by the core network to the base station, and the capability indication information indicates whether the UE supports the auxiliary receiver.

For example, the core network may carry the capability indication information in a paging message and transmit it to the base station.

In one embodiment, the paging message may carry capability indication information indicating that the UE can support the auxiliary receiver. If the paging message does not carry the capability indication information, it implicitly indicates that the UE does not support the auxiliary receiver.

For example, the core network may carry the capability indication information in, but not limited to, the following message(s):
INITIAL CONTEXT SETUP REQUEST;
UE CONTEXT MODIFICATION REQUEST;
HANDOVER REQUEST; or
PATH SWITCH REQUEST ACKNOWLEDGE.

A specific example is provided below in combination with any of the above embodiments:
1. A terminal reports, to the network, auxiliary information of its use of a separate transceiver (auxiliary receiver).
2. The terminal reports, to the network, capability information indicating that the user supports the separate transceiver:
a) This capability information is notified to the network via UE capability reporting, for example, ultra-low power PEI.
b) As an example, a logical type value (that is, true/false) is used to indicate support or non-support.
c) As an embodiment, this field is optional, and if this filed is not reported, this means that the auxiliary receiver is not supported.
d) A relationship with an existing PEI support capability:

One working mode is as follows: there is no binding relationship with the PEI capability introduced in the R17 version of the protocol, that is, the UE supports low power PEI, but does not necessarily support R17 PEI.

Another working mode is as follows: there is a binding relationship with the PEI capability introduced in the R17 version of the protocol, that is, if the UE supports the low power PEI, the UE necessarily supports the R17 PEI.
3. The reported capability of the terminal can be transmitted between a core network and a base station;
a) As an example: the UE capability is reported to the base station, and the base station then notifies the UE capability to the core network through UE CAPABILITY INFO INDICATION.

The following message may also be used:
RRC INACTIVE TRANSITION REPORT.
b) As an embodiment: the core network transmits the UE capability to the base station in a paging message.

For example, the paging message also carries UE capability information;
if UE capability information is not carried, it is assumed by default that the auxiliary receiver is not supported.
c) As an embodiment: the core network transmits the UE capability to the base station through the following message:
INITIAL CONTEXT SETUP REQUEST;
UE CONTEXT MODIFICATION REQUEST;
HANDOVER REQUEST; or
PATH SWITCH REQUEST ACKNOWLEDGE.
4. The reported capability of the terminal can be transmitted between base stations.

Scenario 1: When a handover occurs, a base station obtains the reported capability of the terminal from a handover request message.
a) As an embodiment, the handover request message may carry the reported capability of the terminal which is reported by the terminal to a base station before the handover.
b) As an embodiment, the handover request message may carry the reported capability of the terminal obtained by the base station from the core network.

Scenario 2: When a UE in an inactive state performs cell reselection, the base station obtains the reported capability of the terminal from an anchor base station:
a) As an embodiment, a UE context response may carry the reported capability of the terminal.
b) An access network paging (RAN Paging) message carries UE capability information.
c) The reported capability of the terminal is transferred from the anchor base station to a non-anchor base station during a UE context acquisition procedure.

5. The network can perform configuration based on auxiliary information indicating that the user wants to work with a separate transceiver:
a) This auxiliary information is reported to the network via UAI.
b) The terminal can report that the terminal wants to work in a working mode using a separate transceiver.
c) The terminal can report the length of time the terminal wants to work in the working mode using the separate transceiver.

6. The terminal capability may or may not be distinguishable between RRC states.
a) No distinction is made between RRC states. That is, whether the terminal supports the working mode using the separate transceiver may be applicable in the idle state and the connected state.
b) Distinction is made between RRC states. That is, whether the terminal supports the working mode using the separate transceiver can be applicable in idle state or the connected state.

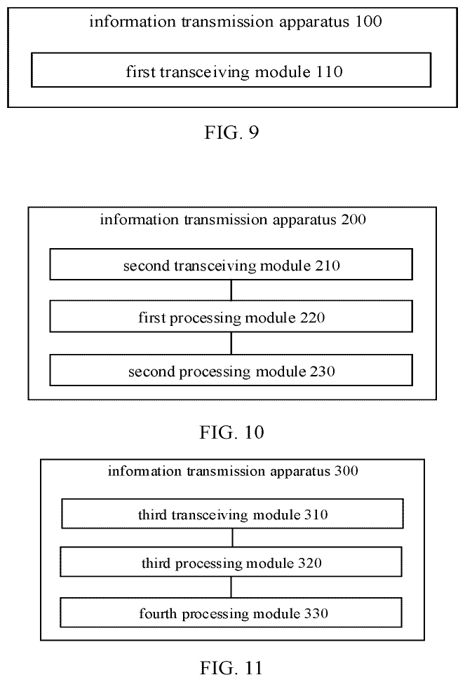

An embodiment of the present disclosure further provides an information transmission apparatus, as shown in FIG. 9. The apparatus is applied to a UE in a cellular mobile wireless communication. The apparatus 100 includes:
a first transceiving module 110 configured to send first capability indication information for indicating whether the User Equipment (UE) supports an auxiliary receiver, where the auxiliary receiver is at least used to monitor a wake-up signal when a main radio of the UE is in a sleep state.

In one embodiment, the first transceiving module 110 is specifically configured to:
send UE capability information carrying the first capability indication information.

In one embodiment, the first capability indication information further includes: auxiliary receiver working indication information, where the auxiliary receiver working indication information is used to indicate at least one of the following:
when the UE supports the auxiliary receiver, whether to use the auxiliary receiver to monitor the wake-up signal; or
when the UE supports the auxiliary receiver, time information for the auxiliary receiver to monitor the wake-up signal.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, the first transceiving module is specifically configured to perform at least one of the following:
sending the first capability indication information to the core network; or
sending the first capability indication information to the base station.

An embodiment of the present disclosure further provides an information transmission apparatus, as shown in FIG. 10. The apparatus is applied to a base station in a cellular mobile wireless communication. The apparatus 200 includes:
a second transceiving module 210 configured to receive first capability indication information for indicating whether a UE supports an auxiliary receiver, where the auxiliary receiver is at least used to monitor a wake-up signal when a main radio of the UE is in a sleep state.

In one embodiment, the second transceiving module 210 is specifically configured to:
receive UE capability information carrying the first capability indication information.

In one embodiment, the apparatus 200 further includes:
a first processing module 220 configured to, in response to that the UE supports using the auxiliary receiver to receive a first wake-up signal, determine that the UE supports using the main radio and/or the auxiliary receiver to receive a second wake-up signal, where the first wake-up signal is different from the second wake-up signal.

In one embodiment, the apparatus 200 further includes:
a second processing module 230 configured to, in response to not receiving the first capability indication information, determine that the UE does not support the auxiliary receiver.

In one embodiment, the first capability indication information further includes: auxiliary receiver working indication information, where the auxiliary receiver working indication information is used to indicate at least one of the following:
when the UE supports the auxiliary receiver, whether to use the auxiliary receiver to monitor the wake-up signal; or
when the UE supports the auxiliary receiver, time information for using the auxiliary receiver to monitor the wake-up signal.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, the second transceiving module 210 is specifically configured to perform at least one of the following:
receiving the first capability indication information sent by the UE;
receiving the first capability indication information sent by a core network; or
receiving the first capability indication information sent by an opposite base station.

In one embodiment, the second transceiving module 210 is further configured to perform at least one of the following:
sending to the opposite base station second capability indication information for indicating whether the UE supports the auxiliary receiver; or
sending to the core network second capability indication information for indicating whether the UE supports the auxiliary receiver.

An embodiment of the present disclosure further provides an information transmission apparatus, as shown in FIG. 11. The apparatus is applied to a core network in a cellular mobile wireless communication. The apparatus 300 includes:
a third transceiving module 310 configured to receive first capability indication information for indicating whether the UE supports an auxiliary receiver, where the auxiliary receiver is at least used to monitor a wake-up signal when a main radio of the UE is in a sleep state.

In one embodiment, the third transceiving module 310 is specifically configured to:
receive UE capability information carrying the first capability indication information.

In one embodiment, the apparatus 300 further includes:
a third processing module 320 configured to, in response to that the UE supports using the auxiliary receiver to receive a first wake-up signal, determine that the UE supports using the main radio and/or the auxiliary receiver to receive a second wake-up signal, where the first wake-up signal is different from the second wake-up signal.

In one embodiment, the apparatus further includes:
a fourth processing module 330 configured to, in response to not receiving the first capability indication information, determine that the UE does not support the auxiliary receiver.

In one embodiment, the first capability indication information further includes: auxiliary receiver working indication information, where the auxiliary receiver working indication information is used to indicate at least one of the following:
when the UE supports the auxiliary receiver, whether to use the auxiliary receiver to monitor the wake-up signal; or
when the UE supports the auxiliary receiver, time information for using the auxiliary receiver to monitor the wake-up signal.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, the third transceiving module 310 is specifically configured to perform at least one of the following:
receiving the first capability indication information sent by the UE; or
receiving the first capability indication information sent by the base station.

In one embodiment, the third transceiving module 310 is further configured to:
send to a base station second capability indication information for indicating whether the UE supports the auxiliary receiver.

In an example embodiment, the first transceiving module 110, the second transceiving module 210, the first processing module 220, the second processing module 230, the third transceiving module 310, the third processing module 320 and the fourth processing module 330 may be implemented by one or more Central Processing Units (CPUs), Graphics Processing Units (GPUs), baseband processors (BPs), Application Specific Integrated Circuits (ASICs), DSPs, Programmable Logic Devices (PLDs), Complex Programmable Logic Devices (CPLDs), Field-Programmable Gate Arrays (FPGAs), general processors, controllers, Micro Controller Units (MCUs), microprocessors, or other electronic components to perform the aforementioned methods.

Further example embodiments are listed in as follows:

According to an aspect of an embodiment of the present disclosure, there is provided an information transmission method. The method is performed by User Equipment (UE), and the method includes:
sending first capability indication information for indicating whether the UE supports an auxiliary receiver, wherein the auxiliary receiver is at least used to monitor a wake-up signal when a main radio of the UE is in a sleep state.

In an embodiment, sending the first capability indication information for indicating whether the UE supports the auxiliary receiver includes:
sending UE capability information carrying the first capability indication information.

In one embodiment, the first capability indication information further includes auxiliary receiver working indication information, and the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, sending the first capability indication information for indicating whether the UE supports the auxiliary receiver includes at least one of the following:
sending the first capability indication information to a core network; or
sending the first capability indication information to a base station.

According to a further aspect of an embodiment of the present disclosure, there is provided an information transmission method. The method is performed by a base station, and the method includes:
receiving first capability indication information for indicating whether the UE supports an auxiliary receiver, wherein the auxiliary receiver is at least used to monitor a wake-up signal when a main radio of the UE is in a sleep state.

In one embodiment, receiving the first capability indication information for indicating whether the UE supports the auxiliary receiver includes:
receiving UE capability information carrying the first capability indication information.

In one embodiment, the method further includes:
in response to that the UE supports using the auxiliary receiver to receive a first wake-up signal, determining that the UE supports using the main radio and/or the auxiliary receiver to receive a second wake-up signal, wherein the first wake-up signal is different from the second wake-up signal.

In one embodiment, the method further includes:
in response to not receiving the first capability indication information, determining that the UE does not support the auxiliary receiver.

In one embodiment, the first capability indication information further includes auxiliary receiver working indication information, and the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, receiving the first capability indication information for indicating whether the UE supports the auxiliary receiver includes at least one of the following:
receiving the first capability indication information sent by the UE;
receiving the first capability indication information sent by a core network; or
receiving the first capability indication information sent by an opposite base station.

In one embodiment, the method further includes at least one of the following:
sending to an opposite base station second capability indication information for indicating whether the UE supports the auxiliary receiver; or
sending to the core network the second capability indication information for indicating whether the UE supports the auxiliary receiver.

According to a further aspect of an embodiment of the present disclosure, there is provided an information transmission method. The method is performed by a core network, and the method includes:
receiving first capability indication information for indicating whether a UE supports an auxiliary receiver, wherein the auxiliary receiver is at least used to monitor a wake-up signal when a main radio of the UE is in a sleep state.

In one embodiment, receiving the first capability indication information for indicating whether the UE supports the auxiliary receiver includes:
receiving UE capability information carrying the first capability indication information.

In one embodiment, the method further includes:
in response to that the UE supports using the auxiliary receiver to receive a first wake-up signal, determining that the UE supports using the main radio and/or the auxiliary receiver to receive a second wake-up signal, wherein the first wake-up signal is different from the second wake-up signal.

In one embodiment, the method further includes:
in response to not receiving the first capability indication information, determining that the UE does not support the auxiliary receiver.

In one embodiment, the first capability indication information further includes auxiliary receiver working indication information, and the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, receiving the first capability indication information for indicating whether the UE supports the auxiliary receiver includes at least one of the following:
receiving the first capability indication information sent by the UE; or
receiving the first capability indication information sent by a base station.

In one embodiment, the method further includes:
sending to a base station second capability indication information for indicating whether the UE supports the auxiliary receiver.

According to a further aspect of an embodiment of the present disclosure, there is provided an information transmission apparatus. The apparatus includes:
a first transceiving module configured to send first capability indication information for indicating whether User Equipment (UE) supports an auxiliary receiver, wherein the auxiliary receiver is at least used to monitor a wake-up signal when a main radio of the UE is in a sleep state.

In one embodiment, the first transceiving module is specifically configured to:
send UE capability information carrying the first capability indication information.

In one embodiment, the first capability indication information further includes auxiliary receiver working indication information, and the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, the first transceiving module is specifically configured to perform at least one of the following:
sending the first capability indication information to a core network; or
sending the first capability indication information to a base station.

According to a further aspect of an embodiment of the present disclosure, there is provided an information transmission apparatus. The apparatus includes:
a second transceiving module configured to receive first capability indication information for indicating whether a UE supports an auxiliary receiver, wherein the auxiliary receiver is at least used to monitor a wake-up signal when a main radio of the UE is in a sleep state.

In one embodiment, the second transceiving module is specifically configured to:
receive UE capability information carrying the first capability indication information.

In one embodiment, the apparatus further includes:
a first processing module configured to, in response to that the UE supports using the auxiliary receiver to receive a first wake-up signal, determine that the UE supports using the main radio and/or the auxiliary receiver to receive a second wake-up signal, wherein the first wake-up signal is different from the second wake-up signal.

In one embodiment, the apparatus further includes:
a second processing module configured to, in response to the first capability indication information not being received, determine that the UE does not support the auxiliary receiver.

In one embodiment, the first capability indication information further includes auxiliary receiver working indication information, and the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, the second transceiving module is specifically configured to perform at least one of the following:
receiving the first capability indication information sent by the UE;
receiving the first capability indication information sent by a core network; or
receiving the first capability indication information sent by an opposite base station.

In one embodiment, the second transceiving module is further configured to perform at least one of the following:
sending to an opposite base station second capability indication information for indicating whether the UE supports the auxiliary receiver; or
sending to a core network the second capability indication information for indicating whether the UE supports the auxiliary receiver.

According to a further aspect of an embodiment of the present disclosure, there is provided an information transmission apparatus. The apparatus includes:
a third transceiving module configured to receive first capability indication information for indicating whether a UE supports an auxiliary receiver, wherein the auxiliary receiver is at least used to monitor a wake-up signal when a main radio of the UE is in a sleep state.

In one embodiment, the third transceiving module is specifically configured to:
receive UE capability information carrying the first capability indication information.

In one embodiment, the apparatus further includes:
a third processing module configured to, in response to that the UE supports using the auxiliary receiver to receive a first wake-up signal, determine that the UE supports using the main radio and/or the auxiliary receiver to receive a second wake-up signal, wherein the first wake-up signal is different from the second wake-up signal.

In one embodiment, the apparatus further includes:
a fourth processing module configured to, in response to the first capability indication information no being received, determine that the UE does not support the auxiliary receiver.

In one embodiment, the first capability indication information further includes auxiliary receiver working indication information, and the auxiliary receiver working indication information is used to indicate at least one of the following:
whether to use the auxiliary receiver to monitor the wake-up signal when the UE supports the auxiliary receiver; or
time information for using the auxiliary receiver to monitor the wake-up signal when the UE supports the auxiliary receiver.

In one embodiment, the first capability indication information is used to indicate at least one of the following:
whether the UE supports the auxiliary receiver in a Radio Resource Control (RRC) connected state; or
whether the UE supports the auxiliary receiver in an RRC non-connected state.

In one embodiment, the third transceiving module is specifically configured to perform at least one of the following:
receiving the first capability indication information sent by the UE; or
receive the first capability indication information sent by a base station.

In one embodiment, the third transceiving module is further configured to:
send to a base station second capability indication information for indicating whether the UE supports the auxiliary receiver.

According to a further aspect of an embodiment of the present disclosure, there is provided a communication device. The communication device includes a processor, a memory, and an executable program stored in the memory and executable by the processor. When the executable program is executed by the processor, steps of the information transmission method described in any one of the above aspects are implemented.

According to an eighth aspect of an embodiment of the present disclosure, there is provided a storage medium, on which an executable program is stored. When the executable program is executed by a processor, steps of the information transmission method described in in any one of the above aspects are implemented.

The information transmission method, apparatus, communication device and storage medium are provided by the embodiments of the present disclosure. The information transmission method includes: sending, by the UE, first capability indication information for indicating whether the UE supports an auxiliary receiver, wherein the auxiliary receiver is at least used to monitor a wake-up signal when a main radio of the UE is in a sleep state. In this way, by sending the first capability indication information from the UE, the network side can determine whether the UE supports the auxiliary receiver. This reduces the misjudgment of the auxiliary receiver support capability of the UE due to the network side's uncertainty about the auxiliary receiver support capability of the UE, and improves the accuracy in determining the auxiliary receiver support capability of the UE by the network side.

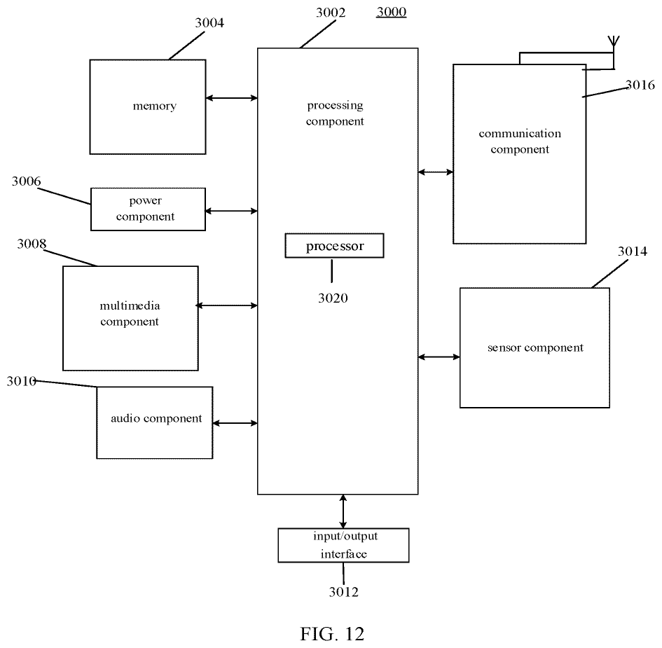

FIG. 12 is a block diagram of a device 3000 for information transmission according to an example embodiment. For example, the device 3000 may be a mobile phone, a computer, a digital broadcast terminal, a messaging device, a gaming console, a tablet, a medical device, exercise equipment, a personal digital assistant, and the like.

Referring to FIG. 12, the device 3000 may include one or more of the following components: a processing component 3001, a memory 3004, a power component 3006, a multimedia component 3008, an audio component 3010, an input/output (I/O) interface 3012, a sensor component 3014, and a communication component 3016.

The processing component 3002 typically controls overall operations of the device 3000, such as the operations associated with display, telephone calls, data communications, camera operations, and recording operations. The processing component 3002 may include one or more processors 3020 to execute instructions to perform all or part of the steps in the above described methods. Moreover, the processing component 3002 may include one or more modules which facilitate the interaction between the processing component 3002 and other components. For instance, the processing component 3002 may include a multimedia module to facilitate the interaction between the multimedia component 3008 and the processing component 3002.

The memory 3004 is configured to store various types of data to support the operation of the device 3000. Examples of such data include instructions for any applications or methods operated on the device 3000, contact data, phonebook data, messages, pictures, video, etc. The memory 3004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 3006 provides power to various components of the device 3000. The power component 3006 may include a power management system, one or more power sources, and any other components associated with the generation, management, and distribution of power in the device 3000.

The multimedia component 3008 includes a screen providing an output interface between the device 3000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 3008 includes a front camera and/or a rear camera. The front camera and the rear camera may receive an external multimedia datum while the device 3000 is in an operation mode, such as a photographing mode or a video mode. Each of the front camera and the rear camera may be a fixed optical lens system or have focus and optical zoom capability.

The audio component 3010 is configured to output and/or input audio signals. For example, the audio component 3010 includes a microphone (“MIC”) configured to receive an external audio signal when the device 3000 is in an operation mode, such as a call mode, a recording mode, and a voice recognition mode. The received audio signal may be further stored in the memory 3004 or transmitted via the communication component 3016. In some embodiments, the audio component 3010 further includes a speaker to output audio signals.

The I/O interface 3012 provides an interface between the processing component 3002 and peripheral interface modules, such as a keyboard, a click wheel, buttons, and the like. The buttons may include, but are not limited to, a home button, a volume button, a starting button, and a locking button.

The sensor component 3014 includes one or more sensors to provide status assessments of various aspects of the device 3000. For instance, the sensor component 3014 may detect an open/closed status of the device 3000, relative positioning of components, e.g., the display and the keypad, of the device 3000, a change in position of the device 3000 or a component of the device 3000, a presence or absence of user contact with the device 3000, an orientation or an acceleration/deceleration of the device 3000, and a change in temperature of the device 3000. The sensor component 3014 may include a proximity sensor configured to detect the presence of nearby objects without any physical contact. The sensor component 3014 may also include a light sensor, such as a CMOS or CCD image sensor, for use in imaging applications. In some embodiments, the sensor component 3014 may also include an accelerometer sensor, a gyroscope sensor, a magnetic sensor, a pressure sensor, or a temperature sensor.

The communication component 3016 is configured to facilitate communication, wired or wirelessly, between the device 3000 and other devices. The device 3000 can access a wireless network based on a communication standard, such as WiFi, 2G, or 3G, or a combination thereof. In one example embodiment, the communication component 3016 receives a broadcast signal or broadcast associated information from an external broadcast management system via a broadcast channel. In one example embodiment, the communication component 3016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the device 3000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 3004 including instructions executable by the processor 3020 in the device 3000, for performing the above-described methods. For example, the non-transitory computer-readable storage medium may be a ROM, a Random Access Memory (RAM), a CD-ROM, a magnetic tape, a floppy disc, an optical data storage device, and the like.

Other embodiments of the disclosure will be apparent to those skilled in the art from consideration of the specification and practice of the disclosure disclosed here. This application is intended to cover any variations, uses, or adaptations of embodiments of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that embodiments of the present disclosure are not limited to the exact construction that has been described above and illustrated in the accompanying drawings, and that various modifications and changes can be made without departing from the scope thereof. It is intended that the scope of embodiments of the present disclosure only be limited by the appended claims.

1. An information transmission method, wherein the method is performed by User Equipment (UE), and the method comprises:
sending first capability indication information for indicating whether the UE supports an auxiliary receiver, wherein the auxiliary receiver is at least used to monitor a wake-up signal in response to that a main radio of the UE is in a sleep state.

2. The method according to claim 1, wherein sending the first capability indication information for indicating whether the UE supports the auxiliary receiver comprises:
sending UE capability information carrying the first capability indication information.

3. The method according to claim 1, wherein the first capability indication information further comprises auxiliary receiver working indication information, and wherein the auxiliary receiver working indication information is used to indicate at least one of the following:
whether to use the auxiliary receiver to monitor the wake-up signal in response to that the UE supports the auxiliary receiver; or
time information for using the auxiliary receiver to monitor the wake-up signal in response to that the UE supports the auxiliary receiver.

4. The method according to claim 1, wherein the first capability indication information is used to indicate at least one of the following:
whether the UE supports the auxiliary receiver in a Radio Resource Control (RRC) connected state; or
whether the UE supports the auxiliary receiver in an RRC non-connected state.

5. The method according to claim 1, wherein sending the first capability indication information for indicating whether the UE supports the auxiliary receiver comprises at least one of the following:
sending the first capability indication information to a core network; or
sending the first capability indication information to a base station.

6. An information transmission method, wherein the method is performed by a base station, and the method comprises:
receiving first capability indication information for indicating whether User Equipment (UE) supports an auxiliary receiver, wherein the auxiliary receiver is at least used to monitor a wake-up signal in response to that a main radio of the UE is in a sleep state.

7. The method according to claim 6, wherein receiving the first capability indication information for indicating whether the UE supports the auxiliary receiver comprises:
receiving UE capability information carrying the first capability indication information.

8. The method according to claim 6, further comprising:
in response to that the UE supports using the auxiliary receiver to receive a first wake-up signal, determining that the UE supports using at least one of the main radio or the auxiliary receiver to receive a second wake-up signal, wherein the first wake-up signal is different from the second wake-up signal.

9. The method according to claim 6, further comprising:
in response to not receiving the first capability indication information, determining that the UE does not support the auxiliary receiver.

10. The method according to claim 6, wherein the first capability indication information further comprises auxiliary receiver working indication information, and the auxiliary receiver working indication information is used to indicate at least one of the following:
whether to use the auxiliary receiver to monitor the wake-up signal in response to that the UE supports the auxiliary receiver; or
time information for using the auxiliary receiver to monitor the wake-up signal in response to that the UE supports the auxiliary receiver.

11. The method according to claim 6, wherein the first capability indication information is used to indicate at least one of the following:
whether the UE supports the auxiliary receiver in a Radio Resource Control (RRC) connected state; or
whether the UE supports the auxiliary receiver in an RRC non-connected state.

12. The method according to claim 6, wherein receiving the first capability indication information for indicating whether the UE supports the auxiliary receiver comprises at least one of the following:
receiving the first capability indication information sent by the UE;
receiving the first capability indication information sent by a core network; or
receive the first capability indication information sent by an opposite base station.

13. The method according to claim 6, wherein the method further comprises at least one of the following:
sending to an opposite base station second capability indication information for indicating whether the UE supports the auxiliary receiver; or
sending to a core network the second capability indication information for indicating whether the UE supports the auxiliary receiver.

14. An information transmission method, wherein the method is performed by a core network, and the method comprises:
receiving first capability indication information for indicating whether User Equipment (UE) supports an auxiliary receiver, wherein the auxiliary receiver is at least used to monitor a wake-up signal in response to that a main radio of the UE is in a sleep state.

15.-24. (canceled)

25. A communication device, comprising a processor, a memory, and an executable program stored in the memory and executable by the processor, wherein when the executable program is executed by the processor, steps of the information transmission method according to claim 1 are implemented.

26. A non-transitory computer-readable storage medium having an executable program stored thereon, wherein when the executable program is executed by a processor, steps of the information transmission method according to claim 1 are implemented.

27. A communication device, comprising a processor, a memory, and an executable program stored in the memory and executable by the processor, wherein when the executable program is executed by the processor, steps of the information transmission method according to claim 6 are implemented.

28. A communication device, comprising a processor, a memory, and an executable program stored in the memory and executable by the processor, wherein when the executable program is executed by the processor, steps of the information transmission method according to claim 14 are implemented.

29. A non-transitory computer-readable storage medium having an executable program stored thereon, wherein when the executable program is executed by a processor, steps of the information transmission method according to claim 6 are implemented.

30. A non-transitory computer-readable storage medium having an executable program stored thereon, wherein when the executable program is executed by a processor, steps of the information transmission method according to claim 14 are implemented.
